(19) United States
(12) Patent Application Publication
(10) Pub. No.: US 2023/0232808 A1
(43) Pub. Date: Jul. 27, 2023

(54) Magnetic Fishing Accessory Caddy

(71) Applicant: Kerry L. Shaver, Albertville, AL (US)

(72) Inventor: Kerry L. Shaver, Albertville, AL (US)

(21) Appl. No.: 18/096,153

(22) Filed: Jan. 12, 2023

Related U.S. Application Data
(60) Provisional application No. 63/298,716, filed on Jan. 12, 2022.

(51) Int. Cl. A01K 97/22; A01K 97/06

(52) U.S. Cl. CPC A01K 97/22; A01K 97/06

(57) ABSTRACT

A magnetic caddy is provided for releasably affixing metal-based accessories, such as lures, snips, scissors, etc., to the caddy. In one embodiment, the caddy is formed from a planar flexible body that may be wrapped around a pedestal of a boat seat and secured around the pedestal. In another embodiment, the caddy is formed from a planar flexible body that may be adhered via an adhesive, such as double-sided tape, to a flat surface.

### REFERENCE TO RELATED APPLICATIONS

This application is a continuation of, and claims priority to, U.S. Provisional Pat. Application No. 63/298,716, filed on Jan. 12, 2022, and titled “Magnetic Fishing Accessory Caddy,” which is incorporated herein by reference.

### BACKGROUND AND SUMMARY

The caddy according to the present disclosure provides quick and easy access to fishing accessories for anglers. In one embodiment, the fishing accessory caddy is a magnetic wrap with a hook and loop closure that is designed to wrap around the pedestal of a boat seat and hold lures, hooks, snips, scissors and other metal accessories. In another embodiment, the caddy is generally flat and can be adhered to a surface to keep fishing accessories within easy reach.

### BRIEF DESCRIPTION OF THE DRAWINGS

The disclosure can be better understood with reference to the following drawings. The elements of the drawings are not necessarily to scale, emphasis instead being placed upon clearly illustrating the principles of the disclosure. Furthermore, like reference numerals designate corresponding parts throughout the several views.

FIG. 1 depicts a caddy installed on the pedestal of a boat seat in use to hold accessories, according to an embodiment of the present disclosure.

FIG. 2 depicts a top view of the caddy of FIG. 1.

FIG. 3 is a front plan view of the caddy of FIG. 1.

FIG. 4 is a rear plan view of the caddy of FIG. 1.

FIG. 5 is a cross-sectional view of a pocket of the caddy of FIG. 3.

FIG. 6 depicts another embodiment of a caddy in which the caddy is generally flat and affixable to a flat surface.

FIG. 7 is cross-sectional view of a pocket of the caddy of FIG. 6.

### DETAILED DESCRIPTION

FIG. 1 depicts a caddy 100 installed on a pedestal 101 of a boat seat 102, according to an embodiment of the present disclosure. The caddy 100 is configured to releasably hold accessories 103 used by anglers in fishing from a boat. The caddy 100 has magnets (not shown) to which the metal accessories 103 are attracted, causing the accessories to releasably attach an outer surface 104 of the caddy 100. Exemplary accessories 103 may include lures, hooks, snips, scissors and pliers. The only limitation is that the accessories must have sufficient metal content to be attracted to the magnets within the caddy 100.

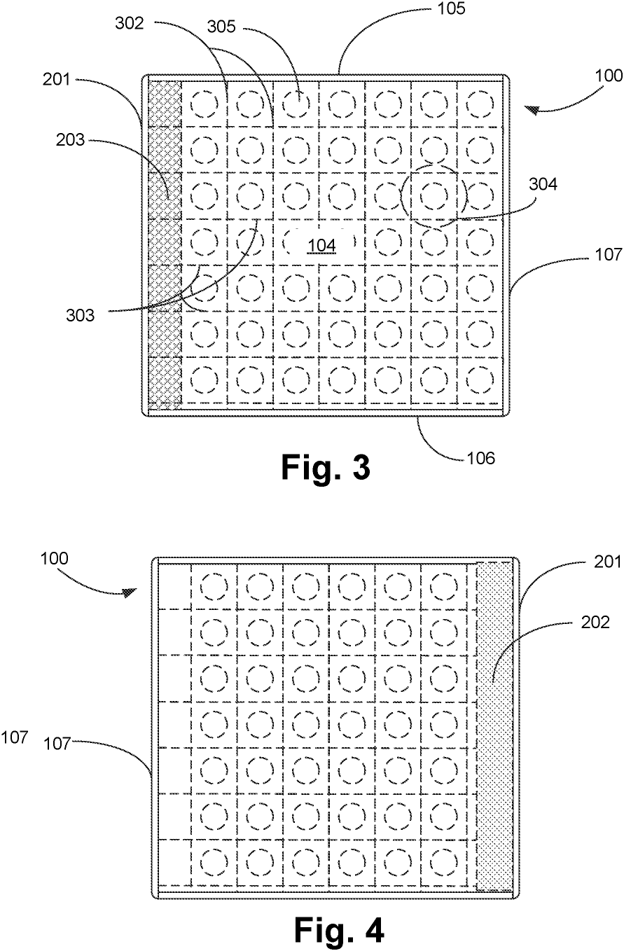

In the illustrated embodiment, the caddy 100 comprises a cylindrical tube shape when installed on the pedestal 101. Before installation on the pedestal 101, the caddy 100 is generally flat and generally rectangular, as shown in FIG. 3. The caddy 100 is formed from flexible material that wraps around the pedestal 101 and secures to itself, as further discussed herein, to form the generally cylindrical tube shape illustrated.

The pedestal 101 is a vertical support extending between a floor 108 of a boat (not shown) and the boat seat 102 and supports the boat seat 102.

The caddy 100 comprises a top edge 105, a bottom edge 106, and first and second lateral side edges. The first lateral side edge 107 is shown in FIG. 1. The second lateral side edge is not illustrated in FIG. 1 because it is covered by the first lateral side edge 107.

A fastener (not shown) on the first lateral side edge 107 and second lateral side edge fastens the first lateral side edge 107 to the second lateral side edge when the caddy 100 is installed on the pedestal 101. In one embodiment, a hook and loop style closure along the first and second lateral side edges mates together to close the caddy 100 around the pedestal 101.

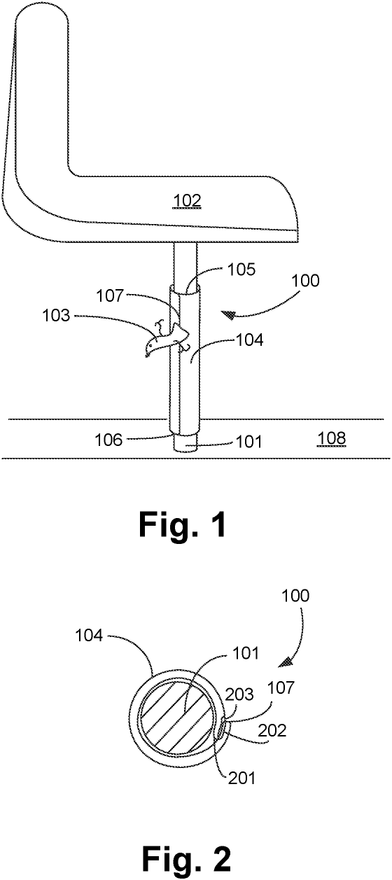

FIG. 2 depicts a top view of the caddy 100 of FIG. 1, with the pedestal 101 shown in cross-section. The caddy 100 wraps around the pedestal 101 and the first lateral side edge 107 overlaps a second lateral side edge 201. A fastener 202 on the underside of the first lateral side edge 107 (e.g., a hook and loop style closure) engages with a fastener 203 on the second lateral side edge 201 to secure the caddy 100 around the pedestal 101. Then the accessories 103 (FIG. 1) can be releasably affixed to the outer surface 104 of the caddy as discussed above. Although the illustrated embodiment depicts a hook and loop style fastener, other fastening means could alternatively be employed to secure the first lateral side edge 107 to the second lateral side edge 201. For example, magnets, hook and loop closures, snaps, or the like could be used as fasteners.

FIG. 3 is a front plan view of one embodiment of the caddy 100 of FIG. 1, before the caddy 100 is installed on the pedestal of a boat seat as illustrated in FIG. 1. Before installation, the caddy 100 is a generally flat planar flexible rectangular body. The caddy 100 is formed from water resistant material in one embodiment. A strip 203 of hook-type material is disposed along the second lateral side edge 201 of the caddy 100. The hook-type material is of the kind that releasably mates with loop-type material, commonly branded as Velcro®.

A strip (not shown) of loop-type material is disposed along the underside (not shown) of the first lateral side edge 107 of the caddy 100 to mate with the strip 203 of hook-type material when the caddy 100 is installed on the boat pedestal as discussed herein.

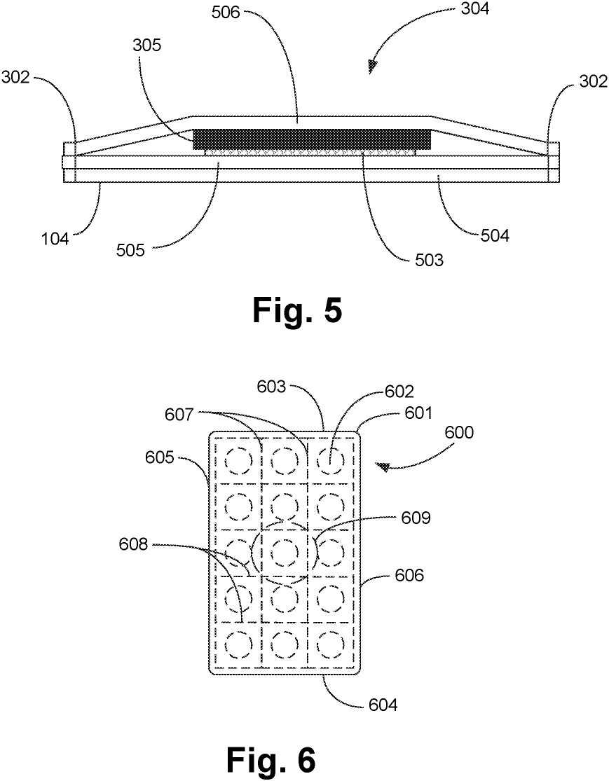

A plurality of vertical seams 302 extend generally parallel to one another as shown, and are generally perpendicular to a plurality of horizontal seams 303 extending parallel to one another. The seams 302 and 303 are formed from thread that affixes the layers of material forming the caddy body together, as further illustrated in FIG. 5 herein. The vertical seams 302 intersect with the horizontal seams 303 to form pockets 304 which contain the magnets 305. In this regard, the magnets are “sewn into” the caddy, generally one in every pocket 304. However, on the second lateral side edge 201, there may not be magnets where the hook strip mates with the loop strip, as further discussed herein.

In one embodiment, the horizontal seams 303 are spaced about 3 cm from one another and the vertical seams 302 are spaced about 3 cm from one another, such that the pockets 304 are generally 3 cm square. The magnets (not shown) sewn into the pockets are generally circular and by necessity are smaller in diameter than 3 cm.

FIG. 4 is a rear plan view of the caddy 100 of FIG. 3. A strip of loop-type material 202 is disposed along the second lateral side edge 201. The loop-type material is of the kind that releasably mates with hook-type material, commonly branded as Velcro®. When the caddy 100 is installed as discussed with respect to FIG. 1, the strip 202 releasably attaches to the strip 203 (FIG. 3) to secure the caddy 100 around the pedestal 101 of the boat seat. When the caddy 100 is installed, it forms a cylindrical shape slightly larger than the diameter of the pedestal.

FIG. 5 is a cross-sectional view of a pocket 304 of the caddy 100 of FIG. 3, showing exemplary layers 504-506 of material that forms the caddy 100 in one embodiment of the caddy 100. The exemplary pocket 305 comprises a magnet 305 “sandwiched” between an innermost layer 506 of material and layer 505 of material. The magnet 305 is adhered to the layer 505 via an adhesive 503 in the illustrated embodiment. Securing the magnet 305 to the layer 505 keeps the magnet in place during sewing of the seams 302 and 303 discussed above with respect to FIG. 3. An outermost layer 504 of material is formed from snag-resistant material, PVC-based plastic material in one embodiment. Seams 302 and 303 (only 302 are shown in FIG. 5) are sewn between adjacent magnets 305 to form the pockets 304.

Using snag-resistant material for the outermost layer 504 prevents the hooks (not shown) of lures affixed to the caddy from snagging on the caddy.

FIG. 6 depicts another embodiment of a caddy 600, in which the caddy 600 is generally flat and affixable to a flat surface instead of being wrapped around a pedestal as discussed above. In this embodiment, the caddy 600 comprises a rectangular body 601 with a plurality of magnets 602 sandwiched between layers of material. The body 601 comprises a top edge 603, a bottom edge 604, and two opposed side edges 605 and 606.

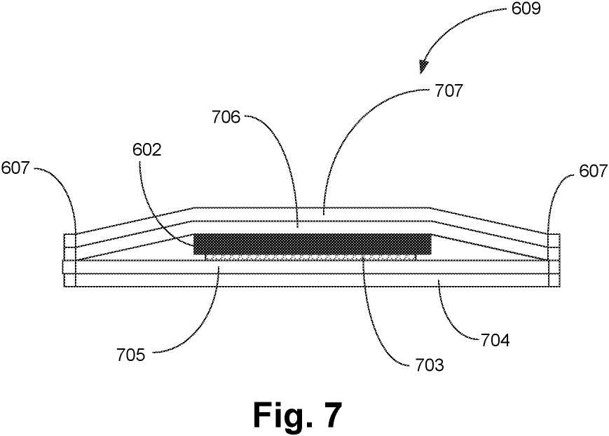

A plurality of vertical seams 607 extend generally parallel to one another as shown, and are generally perpendicular to a plurality of horizontal seams 608 extending parallel to one another. The seams 607 and 608 are formed from thread that affixes the layers of material forming the caddy body together, as further illustrated in FIG. 7 herein. The vertical seams 607 intersect with the horizontal seams 608 to form pockets 609 which contain the magnets 602. In this regard, the magnets are “sewn into” the body of the caddy 600, generally one magnet 602 in every pocket 609.

FIG. 7 is a cross-sectional view of a pocket 609 of FIG. 6, showing exemplary layers of material that form the caddy 600 in one embodiment on the caddy 600. The exemplary pocket 609 comprises a magnet 602 “sandwiched” between layer 706 of material and layer 705 of material. The magnet 602 is adhered to the layer 705 via an adhesive 703 in the illustrated embodiment. Securing the magnet 602 to the layer 705 keeps the magnet in place during sewing of the seams 607 and 608 discussed above with respect to FIG. 6. An outermost layer 704 of material is formed from snag-resistant material, PVC-based plastic material in one embodiment. Seams 607 and 608 (only seams 607 are shown in FIG. 7) are sewn between adjacent magnets 602 to form the pockets 609.

In this embodiment, an additional smooth layer 707 is disposed inside of the layer 706. In one embodiment the smooth layer 707 is formed from smooth plastic configured to adhere to a double-sided tape pad (not shown) that can be affixed to the smooth layer 707 to attach the caddy 600 to a surface. In one embodiment, the double-sided tape pad is a sheet of 3M® double-sided tissue tape. In other embodiments, other types of tape or adherents may be used to affix the caddy to a surface for use.

What is claimed is:

1. A magnetic caddy for releasably affixing metal-based accessories to the caddy, the caddy comprising:
a substantially planar body formed from flexible material, an outermost layer of flexible material comprising snag-resistant material;
a plurality of magnets disposed within the body, the magnets configured to attract and releasably retain the metal-based accessories on the outermost layer of flexible material.

2. The caddy of claim 1, further comprising a plurality of seams sewn into the planar body between adjacent magnets to form pockets within which the magnets are disposed.

3. The caddy of claim 2, wherein the plurality of seams comprises a plurality of substantially vertical seams intersecting with a plurality of substantially horizontal seams.

4. The caddy of claim 2, further comprising an adhesive configured to secure each magnet to a layer of material during the sewing of the seams.

5. The caddy of claim 1, wherein the body is conformable and securable around a pedestal of a boat seat into a substantially cylindrical shape.

6. The caddy of claim 5, wherein the body further comprises fasteners along at least two opposed edges of the body, the fasteners configured to secure the opposed edges together around the pedestal.

7. The caddy of claim 6, wherein the fasteners comprise a strip of hook-type material and a strip of loop-type material, and wherein the hook-type material is secured to one of the opposed edges of the body and the loop-type material is secured to the other of the opposed edges of the body.

8. The caddy of claim 2, the body comprising a smooth plastic layer for adhering adhesive to the body to affix it to a surface.

9. A method for forming a magnetic caddy for releasably affixing metal-based accessories to the caddy, the method comprising:
adhering a first side of each of a plurality of magnets to a first piece of flexible material with an adhesive;
aligning a second piece of flexible material to a second side of each of the plurality of magnets, covering the magnets with the second piece of flexible material;
sewing a plurality of intersecting horizontal seams and vertical seams of thread between adjacent magnets, further securing each magnet within a pocket formed by the intersecting horizontal seams and vertical seams and forming a caddy body.

10. The method of claim 9 further comprising affixing a fastener to each opposed edge of the caddy body such that the opposed edges may be secured together.

11. The method of claim 9 further comprising sewing a smooth plastic layer on an inner side of the body.

12. The method of claim 9 further comprising sewing a snag-resistant outer layer on the outer side of the body.
